(19) United States
(12) Patent Application Publication
(10) Pub. No.: US 2003/0215315 A1
(43) Pub. Date: Nov. 20, 2003

(54) Front-loading refuse body with ejection wall

(75) Inventors: Robert D. Jones, Guttenberg, IA (US); Virgil Collins, Guttenberg, IA (US); Marlin L. Johnson, Guttenberg, IA (US); Randy J. Heller, Garnavillo, IA (US); Jeffrey E. Errthum, Holy Cross, IA (US); Jared L. Rowland, Dyersville, IA (US); Kenneth D. Goedken, Dubuque, IA (US)

Correspondence Address: Allan L. Harms, Suite 420, 2750 First Avenue N.E., Cedar Rapids, IA, 52402, US

(73) Assignee: Kann Manufacturing Corporation, Guttenberg, IA

(21) Appl. No.: 10/410,985

(22) Filed: Apr. 10, 2003

Related U.S. Application Data
(60) Provisional application No. 60/380,988, filed on May 15, 2002.

(51) Int. Cl. B65F 1/00

(52) U.S. Cl. 414/517

(57) ABSTRACT

An improved front-loading refuse collection body includes an ejector panel which is moveable from a position immediately adjacent the front end wall of the storage compartment of the refuse collection body to a second position at the open rear end of the storage compartment. A hydraulic cylinder is mounted to the center of the panel and has a rod which extends at a perpendicular from the panel and is mounted at its distal end to the front wall of the storage compartment. The panel has an opening which is in registry with the opening in the front wall of the storage compartment through which refuse is pushed by the compaction blade of the compaction compartment forward of the front wall of the storage compartment.

### CROSS-REFERENCE TO RELATED APPLICATIONS

This application claims priority from copending provisional patent application entitled “A GUIDED MOVEABLE PUSH OUT WALL OR EJECT PANEL WITH AN OPENING OR APERTURE TO COMPACT THROUGH FOR A REFUSE COLLECTION VEHICLE”, serial No. 60/380,988 filed May 15, 2002. The disclosure of provisional patent application serial No. 60/380,988 is hereby incorporated in its entirety.

### STATEMENT REGARDING FEDERALLY SPONSORED RESEARCH OR DEVELOPMENT

Not Applicable.

### BACKGROUND OF THE INVENTION

The present invention pertains to refuse collection vehicles and particularly to front loading compaction bodies for refuse collection vehicles.

Refuse collection vehicles include those with gravity-dumping bodies and those with rear ejection bodies. All refuse collection vehicles have loading means which may be manual or machine assisted, including either rear end loading or front end loading. In the case of front loading compaction bodies, refuse is loaded into a receiving hopper which serves as a compaction chamber. A compaction blade then forces the refuse from the compaction chamber into a much larger storage compartment of the collection body. When the storage body is fully packed with compacted refuse, the vehicle must move to a landfill or transfer station to empty the storage compartment of the collection body.

A refuse collection vehicle equipped with a gravity-dumping body must open the tailgate of the body and raise the front of the collection body to an angle of forty to fifty degrees with one or more multistage telescoping hydraulic cylinders. Then the refuse can slide from the storage compartment of the gravity-dumping body by gravity. There are disadvantages with this type of body, namely, raising the collection body raises the center of gravity of the vehicle, making it less stable, and this instability is pronounced when the vehicle is being unloaded on soft ground such as at a landfill. On the other hand, when the vehicle is to be emptied within an enclosed transfer station, ceiling height may restrict the operation of the gravity-dumped collection body.

Current refuse collection bodies with powered rear ejection system use multistage telescoping hydraulic cylinders to compact the refuse into the storage compartment, using only one or two stages of the extension of the hydraulic cylinder. When the storage compartment is to be emptied, the tailgate is opened and the compaction blade is used to push the refuse from the open rear end of the body. When the compacted blade is so used the hydraulic cylinder must be more fully extended, using more of its multiple stages. Repetitive extensions and retractions to compact the refuse into the storage compartment causes uneven wear within the hydraulic cylinder due to repeated use of only the first or second stages of the multistage telescoping cylinder, thereby causing more rapid wear on the cylinder components during refuse collection. In addition, the compaction blade which compacts the refuse into the storage compartment must be of sufficient size to cause the refuse within the much larger storage compartment to be ejected.

### BRIEF SUMMARY OF THE INVENTION

The present invention provides solutions to the problems identified by providing an improved front loading, rear ejection refuse collection body. An elongate storage compartment is joined to a compaction chamber into which loose trash is first loaded and then compacted by forcing it through an opening in the front end wall of the storage compartment and also through an opening in an ejection panel assembly located within the storage compartment immediately adjacent the front end wall of the storage compartment. The refuse collection body is provided with a tailgate at its rear end which is opened when compacted refuse in the storage compartment is to be emptied. The ejection panel assembly rests immediately adjacent the front end wall of the storage compartment until unloading is desired, whereupon it may be moved through the storage compartment by action of a hydraulic ram which is mounted upon the ejection panel assembly and pushes against a reinforcing bar mounted across the front end wall. The ejection panel assembly includes a vertical panel which has an aperture through it which aligns with the opening in the front end wall when the ejection panel assembly is in its rest state. The ejection panel assembly also includes a pair of legs which extend perpendicularly from the bottom of the vertical panel and ride along a rail mounted on the floor of the storage compartment. The legs extend forward of the panel while a housing for the hydraulic ram extends rearward of the panel at a perpendicular from the approximate center of the panel. The hydraulic ram is a multistage telescoping hydraulic cylinder which forces the panel through the storage compartment by pushing it away from the front end wall, thereby ejecting the compacted refuse as the ejection panel assembly traverses the storage compartment. The ejection panel assembly completes its rearward movement when the panel is aligned with the open rear end of the storage compartment. The ejection panel assembly is then returned to its rest position immediately adjacent the front wall of the storage compartment and refuse can again by forced through the openings in the front end wall and in the ejection panel into the storage compartment. This structure provides an improved refuse collection body which avoids the need to use a large compaction blade to expel refuse from the storage compartment, and a multistage hydraulic cylinder with a high duty cycle for only the first one or two stages of the telescoping cylinder.

It is therefore an object of the invention to provide an improved front-loading refuse collection body which can be emptied without use of its compaction blade and without use of a multistage telescoping hydraulic cylinder which functions both for compaction and for ejection of refuse from the storage compartment of the refuse collection body.

It is further an object of the invention to provide a front-loading compacting refuse collection body which limits wear on the compaction blade hydraulic cylinder.

It is another object of the invention to provide a refuse collection body which can compact refuse therein and allow exit of the refuse without elevating an end of the refuse collection body.

It is yet another object of the invention to provide a compacting refuse collection body which permits use of a single stage hydraulic cylinder to operate the compaction blade of the collection body.

It is yet a further object of the invention to provide a compacting refuse collection body which may utilize a reduced size compaction blade for thrusting of refuse into the storage compartment of the collection body.

These and other objects will be understood from examination of the detailed description, claims, and drawings which are part of this disclosure.

### BRIEF DESCRIPTION OF THE SEVERAL VIEWS OF THE DRAWING(S)

FIG. 1 is front elevation of a refuse collection truck having the refuse collection body of the present invention, with the front walls of the refuse collection body omitted.

FIG. 2 is front elevation of the refuse collection truck of FIG. 1 with the loading trough of the collection body in its elevated dumping position.

FIG. 3 is front elevation of the refuse collection truck of FIG. 1 with the loading trough omitted and with the compaction blade in its extended position.

FIG. 4 is front elevation of the refuse collection truck of FIG. 1 with the loading trough omitted and with the tailgate open.

FIG. 5 is front elevation of the refuse collection truck of FIG. 4 with the ejection panel assembly partly extended.

FIG. 6 is front elevation of the refuse collection truck of FIG. 4 with the ejection panel assembly fully extended.

FIG. 7 is a front perspective partly exploded view of the refuse collection body 6 shown with the front walls cut away and loader trough omitted.

### DETAILED DESCRIPTION OF THE INVENTION

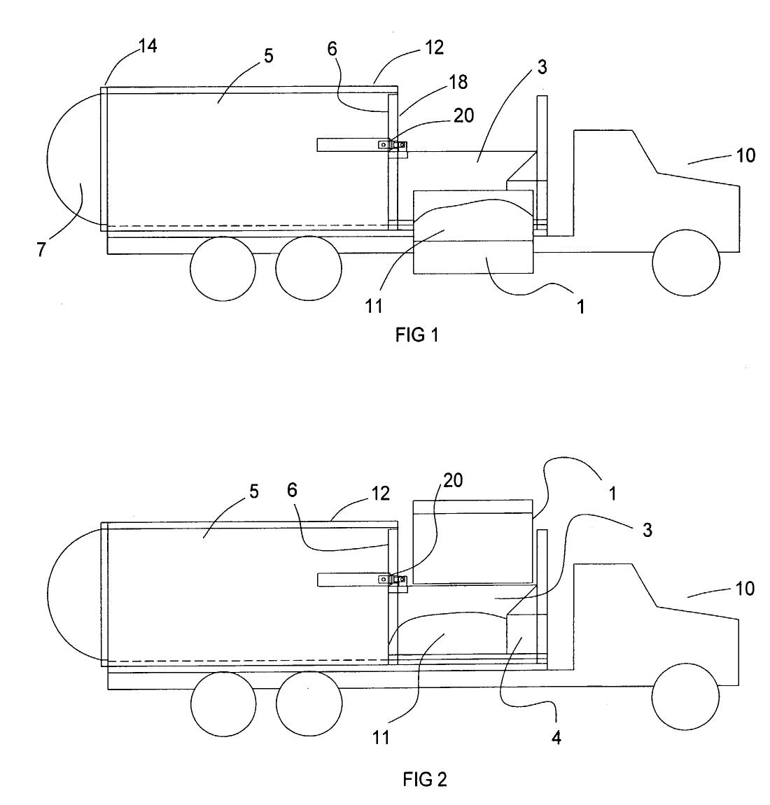

FIGS. 1-6 each provide a front elevational view of a refuse collection truck 10 equipped with the improved refuse collection body 12 of the present invention. The front walls of storage body 5 and compaction chamber 3 have been cut away from FIGS. 1-6. FIGS. 1-6 show various stages of operation of collection body 12. In FIG. 1, refuse collection truck 10 is depicted in condition to receive and store material with tailgate 7 in its closed and locked position over the open rear end 14 of storage compartment 5. Loader trough 1 is shown in its lowered collection position with loose trash 11 contained therein. Compaction chamber 3 is located forward of the front end wall 18 of storage compartment 5. Ejection panel assembly 6 is positioned adjacent front end wall 18 in its position for refuse to be forced into storage compartment 5 from compaction chamber 3. Hydraulic ram 20 is in its fully retracted position.

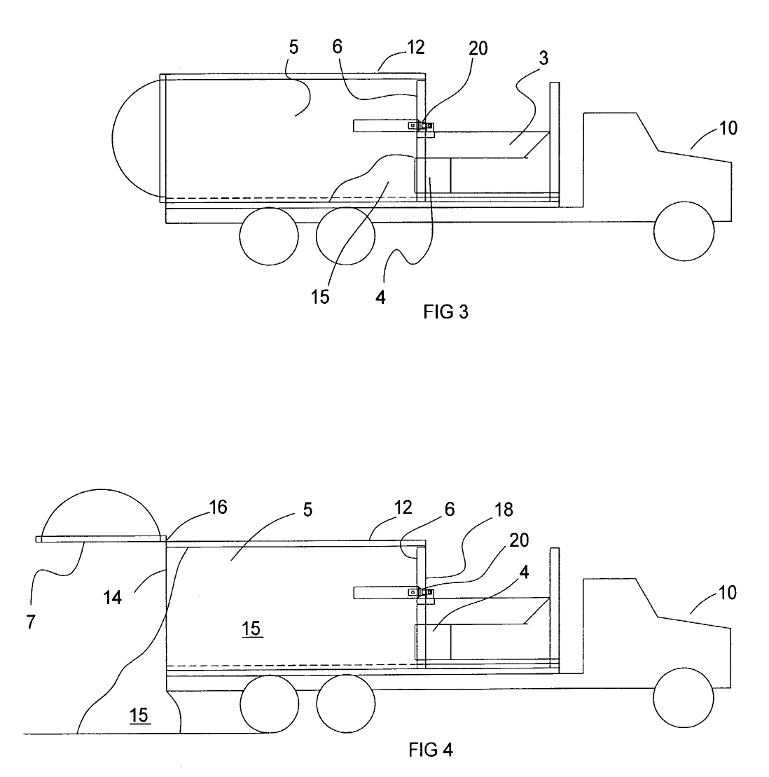

FIG. 2 illustrates refuse collection truck 10 with loader trough 1 in its elevated position. In this position, loader trough 1 is substantially inverted to cause any material therein to fall into compaction chamber 3. When loose trash 11 has dropped into collection chamber 3, compaction blade 4 rests in its retracted position forward of trash 11 ready to compact trash 11 and thrust it into storage compartment 5. Ejection panel assembly 6 remains in its retracted position.

In FIG. 3, loader trough 1 has been omitted. The compaction blade 4 is shown in its extended position having forced compacted refuse 15 into storage compartment 5. Ejection panel assembly 6 remains in its retracted position with hydraulic ram 20 fully retracted.

FIG. 4 illustrates refuse collection truck 10 in position to expel compacted refuse 15 from storage compartment 5 of refuse collection body 12. Tailgate 7 has been unlocked and moved to its open position, rotated to an elevated position about hinges (not shown) on the top 16 of rear end 14 of storage compartment 5. Part of refuse 15 will fall from storage compartment 5 and from within tailgate 7 when tailgate 7 is opened with the remainder of compacted refuse 15 remaining within storage compartment 5. Ejection panel assembly 6 remains in its retracted position forward of compacted refuse 15. Compaction blade 4 is shown in its extended position extending partially through front end wall 18 and through ejection panel assembly 6. Hydraulic ram 20 remains fully retracted.

In FIG. 5, it can be seen that ejection panel assembly 6 has been moved along storage compartment 5 from front end wall 18 thereof toward rear end 14 thereby forcing refuse 15 to exit rear end 14 of storage compartment 5. Ejection panel assembly 6 has been moved toward rear end 14 by use of multistage telescoping hydraulic ram 20 which has extended partly from housing 22. Hydraulic ram 20 pushes against bar 32 of front end wall 18 upon which first end 24 of hydraulic ram 20 is mounted securely. Compaction blade 4 remains in its extended position partly extending through front end wall 18. Ejection panel assembly 6 is guided by rail 36.

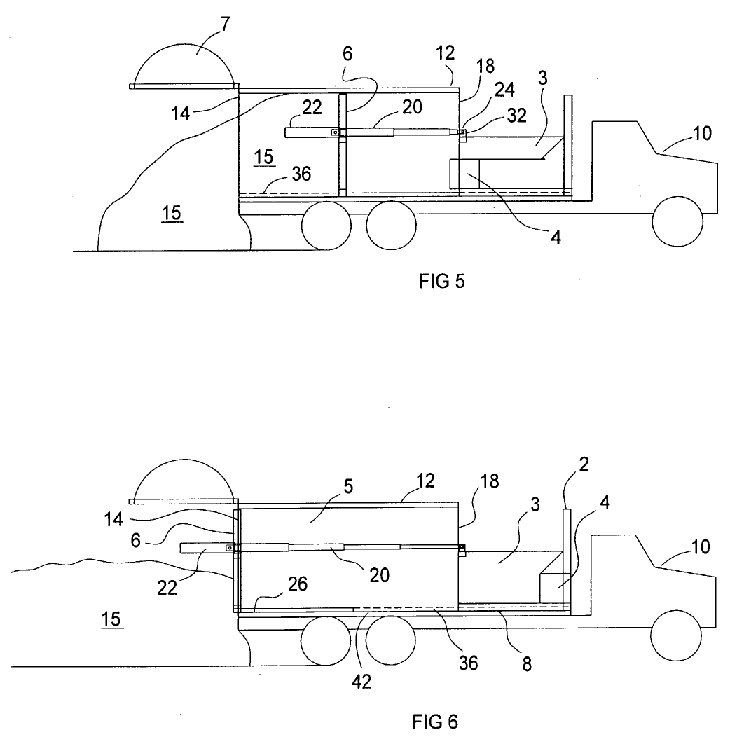

FIG. 6 depicts the refuse collection body 12 with ejection panel assembly 6 thereof moved substantially into alignment with rear end 14 of storage compartment 5, such that housing 22 for hydraulic ram 20 extends from the opening of rear end 14 of storage compartment 5. Hydraulic ram 20 may be a multistage telescoping hydraulic cylinder and in FIG. 6 is shown fully telescopically extended to cause ejection panel to expel all refuse 15 from storage compartment 5. Compaction blade 4 has been retracted to its forward position within compaction chamber 3, there no longer being a need to block refuse from moving into compaction chamber 3.

In FIG. 6, it can be seen that ejection panel assembly 6 is mounted to legs 26 which may slide along floor 42 of storage compartment 5 and along subfloor 8 of compaction chamber 3, guided by and engaged with rail 36 which extends longitudinally from rear end 14 of storage compartment 5 to bulkhead 2. Bulkhead 2 serves as a front wall of compaction chamber 3.

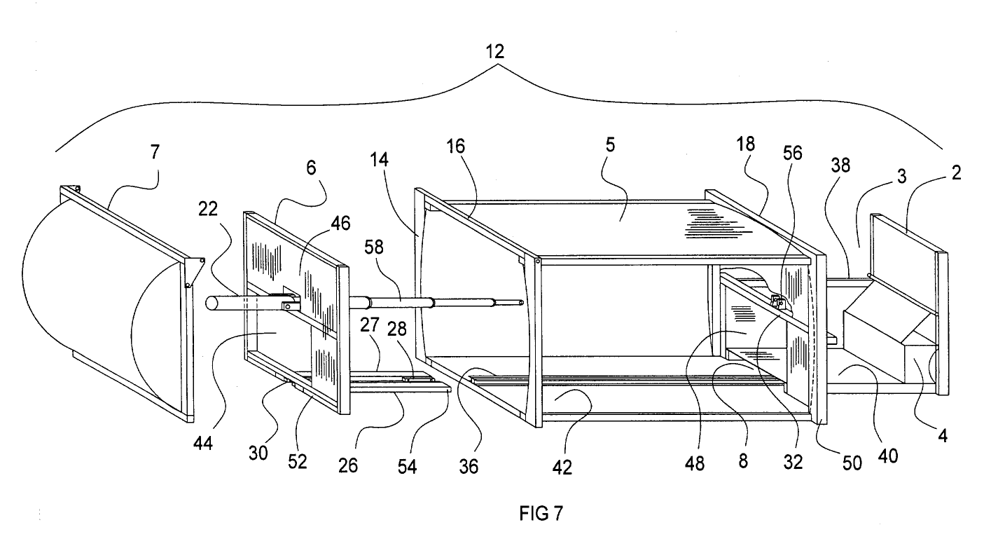

Referring now additionally to FIG. 7, compaction body 12 is illustrated in a partly exploded perspective view with parts omitted, namely, the loader trough and front walls of the storage compartment 5 and compaction chamber 3 have been removed for clarity of illustration.

Compaction body 12 comprises an elongate storage compartment 5 fixed at its front end wall 18 to compaction chamber 3. Compaction chamber 3 extends from rear end 18 and terminates at bulkhead 2 and is provided with opposing sidewalls of which sidewall 38 is seen in FIG. 7. It can be seen that compaction chamber 3 is offset horizontally from the longitudinal axis of storage compartment 5 to provide space for the loader trough (not shown in FIG. 7) to be operationally mounted beside compaction chamber 3. Tailgate 7 is hingedly attached at top 16 of rear 14 of storage compartment 5.

Compaction chamber 3 includes compaction blade 4 which rests alongside bulkhead 2 in its retracted position and is selectively extendable toward storage compartment 5 by sliding along floor platform 40 of compaction chamber 3. When compaction blade 4 is fully extended, it enters opening 48 in front end wall 18 of storage compartment 5, thereby thrusting any loose trash into storage compartment 5, compacting it as it is moved into storage compartment 5. Front end wall 18 is reinforced by bar 32 which, in the preferred embodiment, extends horizontally across front end 18 and is fixed securely to front end frame 50 of storage body compartment 5. Bar 32 is positioned such that it overlies and frames the top of opening 48 in front end wall 18. Bar 32 serves as an anchor for telescoping hydraulic ram 20, rod 58 of which is mounted to rod mount 56. Hydraulic ram 20 extends from housing 22 when compacted refuse 15 is to be ejected from rear 14. Bar 32 is preferably a thick walled rectangular steel tube which can absorb high compaction forces of the refuse being forced into storage compartment 5 by compactor blade 4 and also to absorb high stress when multi-stage telescoping hydraulic ram 20 (See FIG. 5) is extended to push compacted refuse 15 from rear 14 of storage compartment 5.

Rail 36 extends from rear 14 of storage compartment 5 centrally along floor 42 of storage compartment 5 and into compaction chamber 3. Compaction chamber 3 is provided with raised floor platform 40 overlying its subfloor 8 which is coplanar with floor 42 of storage compartment 5. Rail 36 extends linearly into compaction chamber 3 along subfloor 8 below raised floor platform 40. Rail 36 is securely fastened to floor 42 and to subfloor 8 and may be an I-beam.

Ejection panel assembly 6 comprises a vertically oriented panel 46 with legs 26, 27 rigidly fixed to panel 46 at generally the midpoint of lower end 52 thereof. Rail 36 provides guide means for legs 26, 27 of ejection panel assembly 6. Paired legs 26, 27 extend perpendicularly from panel 46 in a direction toward front end wall 18 of storage compartment 5. Legs 26, 27 are parallel and are spaced apart a small distance. Legs 26, 27 include first and second pairs of wear pads 28, 30 respectively. Paired wear pads 28, 30 are mounted to legs 26, 27 in spaced apart opposition and slidingly bear on the side channels of rail 36. These paired wear pads 28, 30 are preferably constructed of “NIHARD” steel. Nylon wear pads or rollers may also be used for assisting the legs 26, 27 in following the rail 36. One pair of wear pads 28 is preferably located adjacent the distal end 54 of legs 26, 27 and the other pair of wear pads 30 is preferably located on legs 26, 27 at their attachment to panel 46. Paired wear pads 28, 30 may be replaceable as needed due to wear.

Ejection panel assembly 6 also comprises a housing 22 which may be cylindrical and houses multi-stage telescoping hydraulic ram 20. Rod 58 of hydraulic ram 20 is extendible toward bar 32 and the distal end thereof is securely attached thereto at mount 56. Housing 22 is securely mounted centrally upon panel 46 and extends at a perpendicular from panel 46 in the direction of tail gate 7. Housing 22 is coaxial with rod 58. Due to this arrangement, the hydraulic ram 20 may be fully retracted into housing 22 when ejection panel assembly 6 is moved fully into its retracted position immediately adjacent front end 18 of storage compartment 5. Panel 46 includes an aperture 44 which is sized and positioned such that it will be in registry with opening 48 in front end 18 when ejection panel assembly 6 is retracted and disposed adjacent front end 18.

Having described the invention, we claim:

1. In a front loading refuse compaction body having a compaction chamber adjacent a storage compartment, the storage compartment having a front end wall and an open rear end and having a tailgate selectively enclosing the rear end, the improvement comprising
an ejector assembly disposed within the storage compartment and selectively moveable from a first position adjacent the front end wall of the storage compartment to a second position spaced away from the front end wall of the storage compartment,
the ejector assembly comprising a vertical panel having a hydraulic ram mounted thereto,
the hydraulic ram having a rod selectively extendible therefrom,
the rod having a distal end fixed to the front end wall,
the front end wall having an opening therethrough,
the vertical panel having an aperture therethrough, the aperture in registry with the opening of the front end wall,
the compaction chamber having a compaction blade operable therewithin to urge refuse within the compaction chamber through the opening of the front end wall and the aperture of the vertical panel and into the storage compartment.

2. The improvement of claim 1 wherein
the ejector assembly further comprises at least one leg extending perpendicularly from a bottom of the panel.

3. The improvement of claim 2 wherein
guide means is mounted to the storage compartment to guide the ejector assembly as it moves from its first position to its second position.

4. The improvement of claim 2 wherein
a rail is mounted to a floor of the storage compartment,
the at least one leg engages the rail.

5. The improvement of claim 4 wherein
the at least one leg is a pair of parallel legs spaced apart a small distance,
the legs of the ejector assembly touchingly engage the rail on opposing sides thereof.

6. The improvement of claim 5 wherein
a wear pad is mounted to each of the legs,
each wear pad opposes the other wear pad,
the wear pads slidingly engaging the rail.

7. The improvement of claim 4 wherein
a pair of wear pads is mounted to each leg,
each wear pad on a first of the pair of legs opposes one of the wear pads mounted to an other of the pair of legs.

8. A front loading refuse compaction body comprising
a storage compartment having a front end wall and an opposing open rear end,
a compaction body mounted at the front end wall of the storage compartment and having a compaction blade therein,
the compaction blade moveable from a first position to a second position to compact refuse in the compaction body,
the front end wall having an opening therein,
the compaction blade receivable within the opening when the compaction blade is in its second position,
the compaction blade urging refuse into the storage compartment through the opening in the front end wall,
an ejector assembly selectively slidable within the storage compartment from a first position immediately adjacent the front end wall of the storage compartment to a second position spaced apart from the first position,
the ejector assembly comprising a vertical panel and a hydraulic ram mounted to the vertical panel,
the panel having an aperture therethrough in registry with the opening in the front end wall,
the hydraulic ram having an extendible rod,
the rod fixed at a distal end thereof to the front end wall,
whereby the vertical panel may be moved toward the open rear end by extension of the rod of the hydraulic ram.

9. The front loading refuse compaction body of claim 8 wherein
the ejector assembly further comprises at least one leg extending at a perpendicular toward the compaction chamber.

10. The front loading refuse compaction body of claim 8 wherein
guide means is provided in the storage compartment to engage the ejector assembly as it moves from its first position to its second position.

11. The front loading refuse compaction body of claim 8 wherein
the ejector assembly further comprises a pair of spaced apart parallel legs extending at a perpendicular from the panel of the ejector assembly.

12. The front loading refuse compaction body of claim 11 wherein
each of the legs includes at least one wear pad thereon,
the at least one wear pad of one of the legs opposes the at least one wear pad on the other of the legs,
a rail is mounted longitudinally within the storage compartment,
the wear pads engage the rail.

13. An ejector for a rear unloading refuse collection body having a front end wall and an open rear end and a floor comprises
a substantially vertical planar panel having a first position immediately adjacent the front end wall and a second position substantially spaced away from the first position thereof,
the panel having a hydraulic cylinder mounted generally centrally thereto,
the hydraulic cylinder having an extendible rod,
the rod extendible at a substantial perpendicular to the panel,
the rod having a distal end mounted to the front end wall of the refuse collection body,
whereby extension and retraction of the rod urges the panel to move between its first position and its second position.

14. The ejector of claim 13 wherein
the cylinder extends from the panel toward the open rear end of the refuse collection body,
the cylinder coaxial with the extendible rod,
the rod of the cylinder may be selectively retracted into the cylinder such that the panel may be positioned in its first position immediately adjacent the front end wall.

15. The ejector of claim 14 wherein
the ejector further comprises at least one leg extending at a substantial perpendicular from a lower edge of the panel,
the at least one leg extending in a direction opposing the second position of the panel.

16. The ejector of claim 15 wherein
a guide is disposed centrally longitudinally along the floor of the refuse collection body,
the at least one leg engaging the guide throughout movement of the panel.

17. The ejector of claim 14 wherein
the panel includes a pair of elongate legs extending from a bottom of the panel at a perpendicular,
the legs engage a guide mounted to the floor of the refuse collection body as the panel moves from its first position to its second position.

18. The ejector of claim 17 wherein
the guide comprises an I-beam mounted longitudinally to the floor of the refuse collection body,
the legs are parallel and spaced apart to engage opposing sides of the I-beam.

19. The ejector of claim 18 wherein
the legs are provided with removable wear pads which bear on the opposing sides of the I-beam.

20. The ejector of claim 19 wherein
the panel includes a opening therethrough substantially in registry with an opening in the front wall of the refuse collection body.
